(19) United States
(12) Patent Application Publication
(10) Pub. No.: US 2015/0006188 A1
(43) Pub. Date: Jan. 1, 2015

(54) COORDINATION OF BENEFITS SYSTEM AND METHOD FOR PAYING PARTICIPATING PHARMACY A PORTION OF A PATIENT'S COPAYMENTS FOR PRESCRIBED MEDICATIONS

(71) Applicant: CLAYTON PUMMILL, UNIVERSITY CITY, MO (US)

(72) Inventor: CLAYTON PUMMILL, UNIVERSITY CITY, MO (US)

(73) Assignee: VALUNET HEALTH, LLC D/B/A MEDHEALTH RX, St. Louis, MO (US)

(21) Appl. No.: 13/928,702

(22) Filed: Jun. 27, 2013

(51) Int. Cl. G06F 19/00

(52) U.S. Cl. CPC G06F 19/3456; G06F 19/328
USPC 705/2

(57) ABSTRACT

The copayment amount due the participating pharmacy a member patient for preparing a compounded or other specialty medication as determined by the Pharmacy Benefit Manager is ascertained by the system. The system calculates the portion of copayment amount that the system is obligated to pay the pharmacy based upon the products used in the preparation of the prescribed medicine obtained by the pharmacy from an affiliated supplier. The system advises the pharmacy of the copayment amount to be paid by the patient. The system then pays the pharmacy the calculated portion of the copayment amount that the system is obligated to pay. The system collects, aggregates and stores data about the transactions between patients and participating pharmacies. It may enhance the stored data by connecting with third party data bases. The data is customized and sold to the participating pharmacies or outside entities.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to pharmacy benefits copayments due from patients for prescription compounded or specialty medications and more particularly to a coordination of benefits system and method for paying a portion of a member patient's copayment to a participating pharmacy based upon the number of products in the prescribed compounded or specialty medication obtained from an affiliated pharmaceutical supplier.

2. Description of Prior Art Including Information Disclosed Under 37 CFR 1.97 and 1.98

Most medical insurance policies cover only a portion of the price charged by a pharmacy for a prescription medication. The payment of the portion of the purchase price not covered by a patient's pharmacy benefits, called the “copayment” or simply the “co-pay,” is the responsibility of the patient. Copayments due from a patient seeking to purchase prescription medicine from a pharmacy can be quite high and therefore may create a financial burden on the patient. That may be particularly true with respect to medications which are custom compounded by pharmacies to fill a particular prescription in accordance with a pre-determined formulation or other “specialty” medications custom prepared to fill the prescription for a particular patient. Because of the labor involved, and the ingredients which must be kept on hand by the pharmacist, those types of prescriptions tend to be expensive and hence require higher copayments from the patient.

An insurance claim from a patient purchasing a prescribed medication is “adjudicated” at the point-of-sale, using the point-of-service systems of various Pharmacy Benefit Managers (“PBMs”). The pharmacy is a Network Provider under various PBM contracts and manuals and is in communication with those PBMs, commonly through an intermediary. The patient is entitled to have their prescriptions filled by any Network Provider pharmacy and to have such prescriptions reimbursed by the PBM associated with the medical insurance company of the patient, to the extent determined by the pharmacy benefits provided by the medical insurance policy of the patient (the “Primary Claim”).

The Network Provider pharmacy has a contractual obligation under the various PBM contracts and manuals to, among other things, collect the patient's copayment, co-insurance, or other patient pay amount (collectively the “copayment”). The copayment is and remains the financial responsibility of the patient. The copayment is a form of cost sharing that holds the patient responsible for a portion of each product/service received.

The copayment amount is usually communicated at the point-of-sale computer system of the Network Provider pharmacy by the PBM through the PBM's point-of-service computer system which is connected by the Internet to the point-of-sale computer system. Generally, under PBM manuals and contracts, the copayment amount must be charged to the patient and cannot be altered, waived, reduced or otherwise not collected by the Network Provider pharmacy. However, the PBM manuals, contracts and National Council for Prescription Drug Programs (NCPDP) guidelines recognize and support the Coordination of Benefits (“COB”) and the submission of a Secondary Claim to a Secondary Payer “for Copayment only.”

At the PBM's point-of-service system, the Primary Claim is adjudicated and a gross amount due is calculated by the PBM associated with the insurer of the patient. The PBM, as Primary Payer, pays a contracted amount to the Network Provider pharmacy. The additional amount owed to the Network Provider pharmacy by the patient is the copayment. Where there is a Secondary Payer involved, the COB segment must be used. The balance remaining, after payment by the Primary Payer (PBM) and by Secondary Payer, is the “Remaining Copayment” obligation of the patient.

Most PBMs support point-of-sale COB using the National Council for Prescription Drug Programs (“NCPDP”) latest version COB segment. NCPDP is the standard format for transmission guidelines applicable to Network Provider pharmacies. The Network Provider pharmacy, under most PBM manuals and contracts, must submit the original patient claim to the Primary Payer for adjudication and payment.

Current NCPDP standards recognize Other Coverage Codes (“OCCs”). NCPDP has various fields, including an “OCC” field. The OCC code is entered by the Network Provider pharmacy and is transmitted to the PBM at the point-of-sale. Currently, NCPDP field 308-C8 is the field in which OCCs are submitted by Network Provider pharmacies. OCC “8” is NCPDP's current code to indicate a Secondary Claim for copayment only within NCPDP field 308-C8.

The present invention relates to a computer-implemented Coordination of Benefits (COB) system and method which pays a portion of the copayment to the Network Provider pharmacy participating in the system, leaving the patient to pay only the Remaining Copayment to the participating pharmacy. The entire copayment obligation is transmitted at the point-of-sale to the COB system of the present invention, which functions as the Secondary Payer. The COB system of the present invention calculates at the point-of-sale the amount of the copayment that the COB system of the present invention is contractually obligated to pay, as the Secondary Payer. The amount of the copayment that the COB system of the present invention is contractually obligated to pay is calculated by the COB system computer based upon the products in the prescribed medicine that the participating pharmacy obtained from a pharmaceutical supplier affiliated with the system. The balance remaining, after payment by the Primary Payer (PBM) and Secondary Payer (the COB system of the present invention) is the “Remaining Copayment” obligation of the patient who is enrolled in the system of the present invention (the “member patient”). The participating pharmacy has a contractual obligation to the COB system of the present invention to collect the entire Remaining Copayment obligation.

Thus, system of the present invention acts as a COB Secondary Payer. As such, it does not pay the full copayment amount (as initially determined by the Pharmacy Benefits Manager). Instead, the COB system of the present invention, pursuant to its contract with the participating pharmacy, adjudicates the Secondary Claim and calculates the Secondary Payer Amount as well as the Remaining Copayment Amount. The Remaining Copayment Amount at the point-of-sale for the Secondary Claim must be sent back for the member patient to pay to the Network Provider pharmacy.

As far as I am aware, there is no COB system or method which presently exists that calculates at the point-of-sale the amount that the system is contractually obligated to pay, as the Secondary Payer, based upon the products in the prescribed medicine that the participating pharmacy obtained from a pharmaceutical supplier affiliated with the COB system. In particular, there is no COB system or method which presently exists that calculates the amount that the system is contractually obligated to pay, as the Secondary Payer, based upon the number of products in the prescribed medicine that the Network Provider pharmacy obtained from a pharmaceutical supplier affiliated with the COB system.

Further, there is no COB system which collects pharmaceutical transactional data relating to the transaction between the member patient and the participating pharmacy in its computer system, and sells components of the collected and stored data. The data may be sold to participating pharmacies or to outside entities such as pharmaceutical marketing companies and wholesale suppliers. The data can be customized depending upon privacy considerations and the needs of the intended purchaser.

Still further, there is no COB system which enhances the stored data which it has collected in its computer system to increase the value thereof. In the present invention, the system enhances the stored data by connecting its computers with third party computer databases to obtain additional information. The additional information may for example include personal health information about the about the patient, information about the products used in preparing the prescribed medication including the sources of such products, information about the physician that prescribed the medication etc.

It is therefore a prime object of the present invention to provide a coordination of benefits system and method for paying a participating pharmacy a portion of a patient's copayment for prescribed medications that calculates the amount of the copayment that the system is contractually obligated to pay, as the Secondary Payer, based upon the products in the prescribed medicine that the participating pharmacy obtained from a pharmaceutical supplier affiliated with the system.

It is another object of the present invention to provide a coordination of benefits system and method for paying a participating pharmacy a portion of a patient's copayment for prescribed medications that calculates the amount of the copayment that the system is contractually obligated to pay, as the Secondary Payer, based upon the number of different products in the prescribed medicine that the Network Provider obtained from a pharmaceutical supplier affiliated with the system.

It is another object of the present invention to provide a coordination of benefits system and method for paying a participating pharmacy a portion of a patient's copayment for prescribed medications which collects and stores data in its computer relating to transactions in which member patients purchase medications from participating pharmacies and sells components of such collected data.

It is another object of the present invention to provide a coordination of benefits system and method for paying a participating pharmacy a portion of a patient's copayment for prescribed medications which collects and stores data in its computer relating to transactions in which member patients purchasing medications from participating pharmacies and enhances the stored data through connections with third party computer databases.

It is another object of the present invention to provide a coordination of benefits system and method for paying a participating pharmacy a portion of a patient's copayment for prescribed medications which in which pharmacies contract with the system to participate in the system.

It is another object of the present invention to provide a coordination of benefits system and method for paying a participating pharmacy a portion of a patient's copayment for prescribed medications in which patients may enroll to become members in the system through a web portal on the system computer accessible through the Internet.

It is another object of the present invention to provide a coordination of benefits system and method for paying a participating pharmacy a portion of a patient's copayment for prescribed medications which is particularly well suited for use by member patients filling prescriptions for compounded or specialty medications.

### BRIEF SUMMARY OF THE INVENTION

In general, the objects set forth above are achieved through a novel method of providing coordination of benefits for an insured member patient seeking to purchase a prescribed compounded or specialty medication from a participating pharmacy after receiving communication with a Pharmacy Benefit Manager responsible for determining the amount of the purchase price of the medication covered by the member patient's pharmacy benefits and the copayment amount due from the member patient. The participating pharmacy obtains one or more products used in preparing the prescribed medication for the member patient from an affiliated pharmaceutical supplier.

The method is carried out by a computer-implemented computer system connected to the Internet and capable of collecting and storing data relating to the transaction between the member patient and the participating pharmacy. The copayment amount due from the member patient as determined by the Pharmacy Benefit Manager is ascertained by the system. The portion of copayment amount that the system is obligated to pay the participating pharmacy is calculated by the system based upon the products used in the preparation of the prescribed medicine obtained by the participating pharmacy from the affiliated supplier. The pharmacy is advised of the copayment amount to be paid by the member patient. The system pays the participating pharmacy the calculated portion of the copayment amount that the system is obligated to pay.

Preferably, the portion of copayment amount that the system is obligated to pay the participating pharmacy is calculated by the system based upon the number of products used in the preparation of the prescribed medicine obtained by the participating pharmacy from the affiliated supplier.

Components of the data collected and stored by the system computer may be sold. The data may be sold to pharmacies participating in the system or to third parties, such as pharmaceutical marketing and wholesale companies.

The collected data may be enhanced by the system through connections with third party computer databases. Such third party databases may contain information about the physician that prescribed the medication for the member patient or about the manufacturer of the products in the prescribed medication. The enhancement may also include collecting personal health information about member patient from the point-of-sale system of the participating pharmacy or by collecting information from the participating pharmacy about the identity and quantity of each product in a prescribed compounded medication created for a member patient.

A contractual relationship between the system and a pharmacy may be created such that the pharmacy becomes a participating pharmacy in the system. Multiple pharmacies may become participating pharmacies in this way. The stored data may be sold to participating pharmacies.

An individual may enroll in the system to become a member patient. A web portal is provided on the system computer through which a patient may enroll to become a member patient by accessing the system computer through the Internet. The enrollment information is communicated to the member patient through the member patient's web portal and to the participating pharmacy. The enrollment information typically includes a member identification number. The member identification number is provided to a participating pharmacy by the member patient when the member patient submits the prescription to the participating pharmacy.

The system may pay the portion of the copayment amount that the system is obligated to pay the participating pharmacy through a third party computer. That third party computer pays the claim for copayment reimbursement directly to the participating pharmacy. The third party computer is connected to the participating pharmacy by the Internet.

The system contracts with at least one wholesale pharmaceutical supplier to become an affiliated pharmaceutical supplier. Preferably, multiple wholesale pharmaceutical suppliers contract to become affiliated pharmaceutical suppliers.

The system periodically invoices the participating pharmacy for the data purchased from the system and other expenses.

In accordance with another aspect of the present invention, a computer-implemented coordination of benefits system is provided for an insured member patient seeking to purchase a prescribed compounded or specially medication from a participating pharmacy after receiving communication from a Pharmacy Benefit Manager responsible for determining the amount of the purchase price of the medication covered by the member patient's pharmacy benefits and the copayment amount due from the member patient. The participating pharmacy obtains one or more products used in preparing the prescribed medication for the member patient from an affiliated pharmaceutical supplier.

The system includes a computer capable of collecting and storing data relating to a transaction between the member patient and the participating pharmacy. The system includes means for ascertaining the copayment amount due from the member patient as determined by the Pharmacy Benefit Manager. Means are provided for calculating the portion of copayment amount that the system is obligated to pay the participating pharmacy based upon the products used in the preparation of the prescribed medicine obtained by the pharmacy from the affiliated supplier. Means are provided for advising the participating pharmacy of the copayment amount to be paid by the member patient. Means are also provided for paying the pharmacy the calculated portion of the copayment amount that the system is obligated to pay the pharmacy.

Preferably, the means provided for calculating the portion of copayment amount that the system is obligated to pay the participating pharmacy calculates that amount based upon the number of products used in the preparation of the prescribed medicine obtained by the participating pharmacy from the affiliated supplier.

The system further comprises means for selling components of the data collected and stored by the system computer. The data may be sold to pharmacies participating in the system or to third parties, such as pharmaceutical marketing and wholesale companies.

Means are provided for enhancing the data collected by the system through connections with third party computer databases. The data enhancing means may communicate with third party databases which contain information about the physician that prescribed the medication for the member patient or about the manufacturer(s) of the products in the prescribed medication. The data enhancement means may include means for collecting personal health information about member patient using the point of sale system of the participating pharmacy or for collecting information from the participating pharmacy about the identity and quantity of each product in a prescribed medication.

Means are provided for creating a contractual relationship between the system and a pharmacy such that the pharmacy becomes a participating pharmacy in the system. Multiple pharmacies may become participating pharmacies through those means. The stored data may be sold to the participating pharmacies.

Means are provided for an individual to enroll in the system to become a member patient. That means may include a web portal is provided on the system computer through which a patient may enroll to become a member patient by accessing the system computer through the Internet.

Means are provided for communicating the enrollment information to the member patient through the member patient's web portal and to the participating pharmacy. The enrollment information typically includes a member identification number. The member identification number is provided to a participating pharmacy by the member patient when the member patient submits the prescription to the participating pharmacy.

In some cases, third party computer means are provided to enable the system to pay the portion of the copayment amount that the system is obligated to pay the participating pharmacy. The third party computer means pays the portion of the copayment amount due from the system directly to the participating pharmacy. Internet means are provided for connecting the third party computer to the point of sale system of the participating pharmacy.

Means are provided to enable the system to contract with at least one wholesale pharmaceutical supplier to become an affiliated pharmaceutical supplier. Preferably, such means are capable of allowing multiple wholesale pharmaceutical suppliers to contract to become affiliated pharmaceutical suppliers.

Means are provided by which the system may periodically invoice the participating pharmacy for the data purchased by the participating pharmacy and other expenses.

### BRIEF DESCRIPTION OF THE SEVERAL VIEWS OF DRAWINGS

To these and to such other objects that may hereinafter appear, the present invention relates to a coordination of benefits system and method for paying a participating pharmacy a portion of a patient's copayment for prescribed medications as described in detail in the following specification and recited in the annexed claims, taken together with the accompanying drawings, in which like numerals refer to like parts and in which:

FIG. 1 is a block diagram illustrating the participants in the coordination of benefits system of the present invention and the communication connections between those participants;

FIG. 2 is a flow chart of the basic steps in the method of present invention in which a patient enrolls as a member of the COB system of the present invention, the COB system obtains the copayment information from the Pharmacy Benefits Manager, calculates the portion of the copayment it is obligated to pay the participating pharmacy, and causes that calculated amount to be paid to the participating pharmacy;

FIG. 3 is a flow chart illustrating the basic steps in the method of the present invention in which the pharmacy enters into a contractual relationship with the COB system, the Secondary Payer Claims is adjudicated by the COB system, the COB system periodically invoices the participating pharmacies and the COB system pays the participating pharmacies the copayment amounts due from the COB system; and

FIG. 4 is a flow chart of the basic steps in the method of the present invention by which the COB system collects, enhances and sells data relating to transactions between member patients and participating pharmacies.

### DETAILED DESCRIPTION OF THE INVENTION

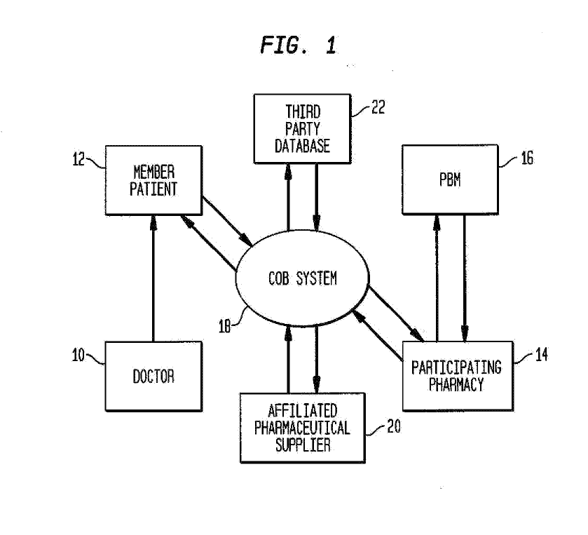

FIG. 1 illustrates the participants in the coordination of benefits system of the present invention. As shown on that figure, a doctor 10 prescribes a compounded or other specialty medication for a member patient 12. Patient 12 goes to a participating pharmacy 14 and presents the prescription to be filled to the pharmacy. Information as to the patient and the prescribed medication is entered into the point-of-sale computer system of pharmacy 14. The pharmacy point-of-sale computer system communicates with the point-of service computer system of the Pharmacy Benefits Manager (PBM) for the patient's medical insurance company. The PBM determines the amount of the purchase price of the prescription covered by the patient's pharmacy benefits (the Primary Claim Amount) and the copayment amount communicates them electronically to the pharmacy point-of-sale computer system.

The pharmacy's point-of sale computer system is connected the computer of the COB system 18, either directly or through an intermediary. The COB system 18 calculates the amount of the patient's copayment that it is obligated to pay (the Secondary Claim Amount) in accordance with the products in the prescribed medicine which pharmacy 14 obtained from pharmaceutical supplier 20 which previously affiliated with COB system 20.

The computer of COB system 18 collects data relating to the transaction between patient 12 and pharmacy 14 from its database and the point-of-sale computer of the pharmacy aggregates and stores the data in the COB system computer. That data may be customized for the needs of particular recipients and revised to address privacy concerns and is sold to participating pharmacies and to outside entities. The stored data may be enhanced by the COB system by communication with third party databases 22 to increase the value thereof.

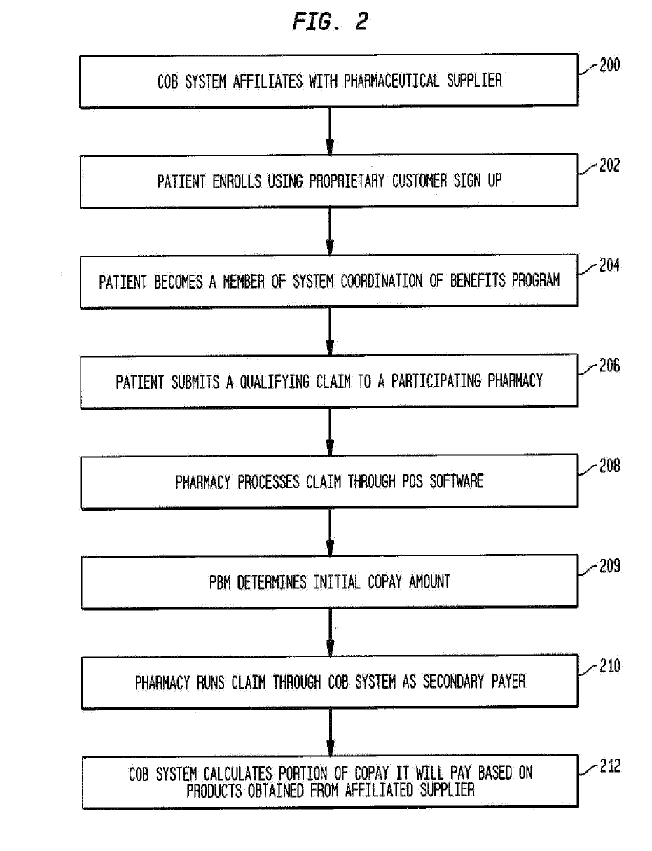

As indicated on FIG. 2, the process begins when the COB system affiliates with one or more suppliers of pharmaceutical products to the participating pharmacy 200. Patients enroll to become a member of the COB 202. This can take place by the patient connecting with the COB system computer through the Internet and navigating to a web portal with proprietary software through which the patient can provide information to the COB system computer using a sign-up form provided at the portal. The patient provides to the COB system the information necessary to become a member and agrees to the terms and condition of membership. If the patient qualifies for membership, the COB system assigns a unique member identification number to the patient 204. The member identification number is communicated to the patient through the web portal for use when the member patient purchases a prescribed medication from a participating pharmacy.

Enrollment may also take place using customized paper forms filled out by the patient and submitted to the system operators. The system operators will enter the information on the forms into the computer of the system.

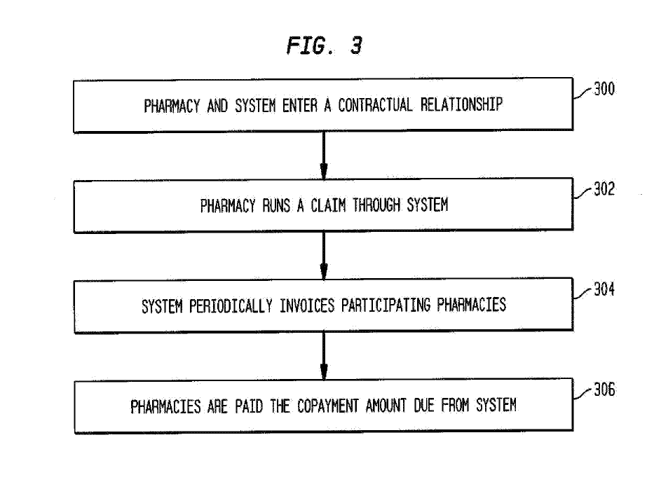

Referring to FIG. 3, a Network Provider pharmacy can contract with the COB system to become a participating pharmacy 300. The system builds a sign up page with a unique URL on its computer for each member pharmacy. The system communicates the enrollment information for each member patient to the participating pharmacy, including the member identification number.

After doctor 10 prescribes a medicine for the member patient 12, the member patient goes to a participating pharmacy 14 and submits a qualifying claim to the pharmacy 206, provides his or her COB system member identification number to the pharmacist along with the prescription. The pharmacist enters information about the patient, including the membership identification number, the medical insurance of the member patient and the prescription into the pharmacies' point-of-sale computer system which automatically processes the insurance claim through the point-of-sale computer system of the pharmacy 208. The claim is processed by communicating with the point-of-service computer system of the PBM associated with the patient's medical insurance company. The PBM advises the pharmacy of the Primary Claim Amount and the copayment due for the prescription. The pharmacy runs the claim through COB system 302 which as the Secondary Payer ascertains the copayment amount, commonly through an intermediary, and calculates the Secondary Claim Amount which it will pay the pharmacy and the Remaining Copayment Amount that the member patient must pay 210 and advises the point-of-sale computer system of the pharmacy accordingly.

The COB system calculates the Secondary Claim Amount based upon the products in the prescription supplied to pharmacy by an affiliated pharmaceutical supplier 212. More particularly, the COB system calculates the Secondary Claim Amount based upon the number of products in the prescription supplied to pharmacy 14 by affiliated pharmaceutical supplier 20.

By way of example, assume a member patient submits a prescription to a participating pharmacy and the PBM determines the copayment amount to be $100. The COB system of the present invention will calculate the portion of the $100 copayment which the system will pay based upon the number of products in the prescribed medication that were obtained by the pharmacy form pharmaceutical company A affiliated with the system.

If the prescription requires one product which was acquired from company A, the system will pay $60 as the Secondary Claim Amount and the member patient will pay the Remaining Copayment Amount of $40 to the pharmacy. If the prescription requires two products which were acquired from company A, the system will pay $70 as the Secondary Claim Amount and the member patient will pay the Remaining Copayment Amount of $30 to the pharmacy. If the prescription requires three products which were acquired from company A, the system will pay $80 as the Secondary Claim Amount and the member patient will pay the Remaining Copayment Amount of $20 to the pharmacy.

The COB system will then advise the participating pharmacy of the Remaining Copayment Amount through the point of sale system of the participating pharmacy. In this way, the pharmacy knows how much of the copayment to collect from the member patient.

The COB system then pays the pharmacy the calculated copayment which it is obligated to pay the pharmacy (the Secondary Claim Amount). That can be done directly but most often is done through an intermediary computer system connected to the point of sale computer system of the participating pharmacy 306.

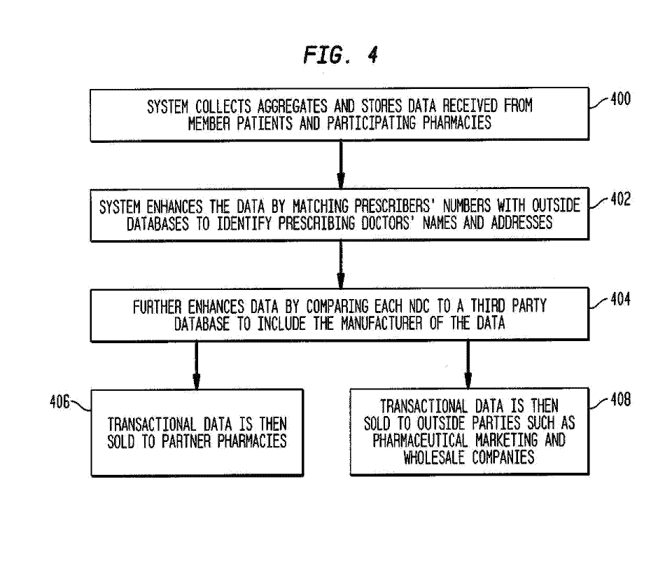

Referring now to FIG. 4, the COB computer collects, aggregates and stores data about member patients and from participating pharmacies related to the transactions between the member patients and the participating pharmacies 400. That data contains information which is valuable to the participating pharmacies and to outside entities such as pharmaceutical marketers and wholesale pharmaceutical companies. The COB may sell that data to the participating pharmacies 406 and outside entities such as pharmaceutical marketing companies and whole pharmaceutical suppliers 408.

However, the COB system may enhance the stored data to increase the value thereof. That can be done by connecting the COB system computer with third party databases 22 to match the prescriber's numbers to identify the names and addresses of prescribing doctors 406. The stored data may also be enhanced by including information as to the manufacturer of the product by connecting to a third party database which associates the data code for each product in the prescribed medication and with information about the manufacturer of that product 404. The enhanced data may be customized for the particular purchaser and to eliminate any privacy issues.

The COB system of the present invention will periodically invoice each participating pharmacy for the data purchased by the pharmacy and for other billable expenses 304.

It will now be appreciated that the present invention is a computer-implemented system and method for providing a coordination of benefits for an insured member patient seeking to purchase a prescribed compounded or specialty medication from a participating pharmacy. The pharmacy is in communication with a Pharmacy Benefit Manager responsible for determining the amount of the purchase price of the medication covered by the medical insurance of the member patient and the copayment amount due from the member patient.

The pharmacy obtains one or more products used in preparing the prescribed medication for the member patient from an affiliated pharmaceutical supplier. The system includes a computer capable of collecting and storing data relating to the transaction between the member patient and the participating pharmacy.

The copayment amount due from the member patient as determined by the Pharmacy Benefit Manager is ascertained by the system. The system calculates the portion of copayment amount that the system is obligated to pay the pharmacy based upon the products used in the preparation of the prescribed medicine obtained by the pharmacy from the affiliated supplier. The system advises the pharmacy of the copayment amount to be paid by the member patient. The system then pays the pharmacy the calculated portion of the copayment amount that the system is obligated to pay.

The system collects, aggregates and stores data about the transactions between the member patients and the participating pharmacies. It may enhance the stored data by connecting with third party data bases to enrich the data with information about the prescribing doctors, the details of the prescribed formulations, the manufacturers of the products in the prescribed medicines and the like. The data is customized and sold to the participating pharmacies or outside entities.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

1. A method of providing coordination of benefits for an insured member patient seeking to purchase a prescribed compounded or specialty medication from a participating pharmacy in communication with a Pharmacy Benefit Manager responsible for determining the amount of the purchase price of the medication covered by the pharmacy benefits of the member patient and the copayment amount due from the member patient, which participating pharmacy obtains one or more products used in preparing the prescribed medication for the member patient from an affiliated pharmaceutical supplier, the method being implemented by a system including a computer capable of collecting and storing data relating to the transaction between the member patient and the participating pharmacy, the method comprising the steps of:
(a) ascertaining the copayment amount due from the member patient as determined by the Pharmacy Benefit Manager;
(b) calculating the portion of copayment amount that the system is obligated to pay the pharmacy based upon the products used in the preparation of the prescribed medicine obtained by the pharmacy from the affiliated supplier;
(c) advising the pharmacy of the copayment amount to be paid by the member patient; and
(d) paying the pharmacy the calculated portion of the copayment amount that the system is obligated to pay the pharmacy.

2. The method of claim 1 wherein the portion of copayment amount that the system is obligated to pay the pharmacy is calculated as a function of the number of different products in the prescribed medication which were obtained by the participating pharmacy from the affiliated pharmaceutical supplier.

3. The method of claim 1 further comprising the step of selling the stored data.

4. The method of claim 1 further comprising the step of enhancing the stored data.

5. The method of claim 4 wherein the step of enhancing the stored data comprises the step of connecting with a third party database to obtain information about the physician that prescribed the medication for the member patient.

6. The method of claim 4 wherein the step of enhancing the stored data comprises the step of connecting with a third party database to obtain information about the manufacturer of the products in the medication prescribed for the member patient.

7. The method of claim 4 wherein the step of enhancing the data comprises the step of collecting personal health information about member patients using the system from the participating pharmacy.

8. The method of claim 4 wherein the step of enhancing the data comprises the step of obtaining information from the participating pharmacy about the identity and quantity of each product in a prescribed medication.

9. The method of claim 1 further comprising the step of creating a contractual relationship between the system and a pharmacy such that the pharmacy becomes a participating pharmacy.

10. The method of claim 3 further comprising the step of creating a contractual relationship between the system and multiple pharmacies such that the pharmacies become participating pharmacies.

11. The method of claim 10 wherein the step of selling data comprises the step of selling stored data to the participating pharmacies.

12. The method of claim 1 further comprising the step of providing a method by which an individual may enroll in the system to become a member patient.

13. The method of claim 12 wherein the method by which an individual may enroll in the system to become a member patient comprises providing a web portal on the system computer through which a patient may become a member patient by accessing the system computer through the internet.

14. The method of claim 13 further comprising the step of communicating enrollment information to the member patient through the web portal and to the participating pharmacy, the enrollment information including a member identification number.

15. The method of claim 1 wherein the a point of sale system of the participating pharmacy ascertains the amount covered by the pharmacy benefits of the member patient as well as the copayment due the participating pharmacy from the member patient for the prescription by accessing one or more external Pharmacy Benefits Manager sources and providing those external Pharmacy Benefits Manager sources with information related to the prescribed medication and information about the medical insurance of the member patient.

16. The method of claim 1 wherein the step of paying the pharmacy the calculated portion of the copayment amount that the system is obligated to pay comprises the step of causing at third party computer to pay the calculated portion of the copayment amount that the system is obligated to pay directly to the participating pharmacy.

17. The method of claim 16 wherein the third party computer is connected to the point of sale system of the participating pharmacy by the Internet.

18. The method of claim 1 further comprising the step of contracting with a wholesale pharmaceutical supplier to become an affiliated pharmaceutical supplier.

19. The method of claim 1 further comprising the step of contracting with multiple wholesale pharmaceutical suppliers to become affiliated pharmaceutical suppliers.

20. The method of claim 1 further comprising the step of providing the patient's member identification number to the participating pharmacy when the patient is enrolled as a member.

21. The method of claim 3 further comprising the step of periodically invoicing each participating pharmacy by the system for the data sold to the participating pharmacy.

22. A computer-implemented system of providing coordination of benefits for an insured member patient seeking to purchase a prescribed compounded or specialty medication from a participating pharmacy in communication with a Pharmacy Benefit Manager responsible for determining the amount of the purchase price of the medication covered by the pharmacy benefits of the member patient and the copayment amount due from the member patient, which pharmacy obtains one or more products used in preparing the prescribed medication for the member patient from an affiliated pharmaceutical supplier, the system including a computer capable of collecting and storing data relating to the transaction between the member patient and the participating pharmacy and comprising means for ascertaining the copayment amount due from the member patient as determined by the Pharmacy Benefit Manager; means for calculating the portion of copayment amount that the system is obligated to pay the pharmacy based upon the products used in the preparation of the prescribed medicine obtained by the pharmacy from the affiliated supplier; means for advising the pharmacy of the copayment amount to be paid by the member patient; and means for paying the pharmacy the calculated portion of the copayment amount that the system is obligated to pay the pharmacy.

23. The system of claim 22 wherein the means of calculating the portion of copayment amount that the system is obligated to pay the pharmacy based upon the products used in the preparation of the prescribed medicine obtained by the pharmacy from the affiliated supplier comprises means for calculating the portion of copayment amount that the system is obligated to pay the pharmacy based upon the number of products used in the preparation of the prescribed medicine obtained by the pharmacy from the affiliated supplier.

24. The system of claim 22 further comprising means for selling components of the stored data.

25. The system of claim 24 further comprising means for enhancing the stored data.

26. The system of claim 25 wherein said means enhancing the stored data comprises means for connecting to a third party database to obtain information about the physician that prescribed the medication for the member patient.

27. The system of claim 25 wherein said means for enhancing the stored data comprises means for connecting to a third party database for obtaining information about the manufacturer of the products in the prescribed medication prescribed for the member patient.

28. The system of claim 25 wherein said means for enhancing the stored data comprises means for collecting personal health information about member patients using the point of sale computer system of the participating pharmacy.

29. The system of claim 25 wherein said means for enhancing the stored data comprises means for collecting information from the participating pharmacy about each product in a prescribed medication created for a member patient.

30. The system of claim 22 further comprising means for creating a contractual relationship between the system and a pharmacy such that the pharmacy becomes a participating pharmacy.

31. The system of claim 22 further comprising means for creating a contractual relationship between the system and multiple pharmacies such that the pharmacies become participating pharmacies.

32. The system of claim 24 wherein said means of selling the stored data comprises means for selling the stored data to participating pharmacies.

33. The system of claim 22 further comprising means by which an individual may enroll in the system to become a member patient.

34. The system of claim 22 further comprising means for providing a web portal on the system computer for a patient to enroll in the system to become a member patient by accessing the system computer through the Internet.

35. The system of claim 34 further comprising means for communicating enrollment information to the member patient through the web portal, said enrollment information including a unique member identification number.

36. The system of claim 22 wherein said means for paying the pharmacy the calculated portion of the copayment amount that the system is obligated to pay the pharmacy comprises means for causing a third party computer to pay the calculated portion of the copayment amount that the system is obligated to pay directly to the participating pharmacy.

37. The system of claim 36 wherein said third party computer is connected to the point of sale system of the participating pharmacy by the Internet.

38. The system of claim 22 further comprising means for the system to contract with a wholesale pharmaceutical supplier to become an affiliated pharmaceutical supplier.

39. The system of claim 22 further comprising means for the system to contract with multiple wholesale pharmaceutical suppliers to become affiliated pharmaceutical suppliers.

40. The system of claim 35 further comprising means for providing to the patient's member identification number to the participating pharmacy.

41. The system of claim 24 further comprising means for periodically invoicing the participating pharmacy for the data sold to that participating pharmacy.
